(19) United States
(12) Patent Application Publication
(10) Pub. No.: US 2023/0257059 A1
(43) Pub. Date: Aug. 17, 2023

(54) HANDLEBAR APPARATUS WITH AN INTEGRAL ELECTRONIC DEVICE

(71) Applicant: Rudi Pienaar, Alpharetta, GA (US)

(72) Inventor: Rudi Pienaar, Alpharetta, GA (US)

(21) Appl. No.: 18/308,659

(22) Filed: Apr. 27, 2023

Related U.S. Application Data
(63) Continuation-in-part of application No. 17/577,008, filed on Jan. 16, 2022, now Pat. No. 11,623,710.
(60) Provisional application No. 63/240,150, filed on Sep. 2, 2021.
(60) Provisional application No. 63/493,534, filed on Mar. 31, 2023.

(51) Int. Cl. B62K 23/02; B62K 11/14; B62J 50/22; B62J 45/422; B62J 45/20; B62J 45/41; B62L 3/00

(52) U.S. Cl. CPC B62K 23/02; B62K 11/14; B62J 50/22; B62J 45/422; B62J 45/20; B62J 45/41; B62L 3/00; B62M 6/45

(57) ABSTRACT

A handlebar apparatus for an electronic vehicle including e-bikes and e-scooters. The handlebar apparatus includes an elongated handlebar having tubular handle portions. The apparatus further includes an electronic device housed within a casing of the handlebar. The handlebar apparatus includes sensors for receiving a throttling input and a braking input. The electronic device can perform most of the electronic operations of the electronic vehicle including receiving the throttling input and braking input and sending commands to the powertrain and braking assembly of the electronic vehicle.

### CROSS-REFERENCE TO RELATED APPLICATIONS

This application is a continuation in part of a U.S. patent application Ser. No. 17/577,008 filed on Jan. 16, 2022, which claims priority from a U.S. provisional patent application Ser. No. 63/240,150, filed on Sep. 2, 2021.

This application also claims priority from a U.S. provisional patent application Ser. No. 63/493,534, filed on Mar. 31, 2023. All of the above applications are incorporated herein by reference in its entirety.

### FIELD OF INVENTION

The present invention relates to a handlebar apparatus for e-mobility vehicles, and more particularly, the present invention relates to a handlebar integrated with an electronic device, and full set of electronic controls.

### BACKGROUND

Electronic vehicles, such as e-bicycles, e-bikes, e-trikes and e-scooters. are becoming increasingly popular for environmental, traffic congestion and personal leisure. Electronic vehicles make almost no noise and create no air pollution. E-bikes are hybrid in that they can be manually and electronically driven. Electronic control units are known for e-bikes, e-scooters, and the like, however, operating the electronic control units is tedious and outdated with the traditional controls and external buttons required for operation. There are multiple buttons and levers to operate the electronic vehicle. Moreover, most of the functions to drive the e-bike are conventional, such as using a throttle and a brake lever. Thus, there is a scope and need for improvements in the operation of electronic two-wheelers and three-wheelers in the e-mobility sector.

Hereinafter, the electronic two and three-wheelers will be referred to as the vehicle and includes e-bikes, e-scooter, e-motorcycle, e-trike, e-bicycle and the like.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a handlebar apparatus for vehicles that have an electronic motor.

It is another object of the present invention that the handlebar houses a fully integrated touch-screen computer that acts as the computer management system and control centre of all the functions of the vehicle.

It is another object of the present invention that a smartphone can connect with the handlebar apparatus.

It is still another object of the present invention that the handlebar apparatus can be dust-resistant and water-resistant.

It is yet another object of the present invention that the handlebar apparatus can be shock resistant.

It is still another object of the present invention that the handlebar apparatus can be controlled by the smartphone and the smartphone can be controlled by the handlebar apparatus.

It is a further object of the present invention that the handlebar apparatus includes an electronically operated throttle via drive-by-wire.

It is still a further object of the present invention that the handlebar apparatus includes electronically operated brakes via brake-by-wire.

It is yet a further object of the present invention that the electronic unit can perform most of the electronic tasks of the vehicle and replace the need for most of the conventional button controls of the vehicle.

It is an additional object of the present invention that the handlebar apparatus can provide an improved operational experience.

In one aspect, disclosed is a handlebar apparatus for vehicles. The handlebar apparatus can include an elongated handlebar having a proximal end and a distal end, and a top and a bottom. Each of the proximal end and the distal hand of the housing can be configured as tubular handles that can be grabbed by the hands of the rider for steering the vehicle. The handlebar can further include a fastener 180 for mounting the handlebar apparatus to a head tube of the frame of the vehicle. The handlebar apparatus can further comprise an electronic device encased within a casing configured in the middle of the handlebar.

In one aspect, the electronic device can include a processor, a memory, communication bus, and networking circuitry. The networking circuitry can connect to an external network, such as Wi-Fi and Bluetooth for connecting to the internet or pairing with an external sensor or computing device, such as a smartphone.

In one implementation of the handlebar apparatus, the external computing device can be a smartphone, wherein the processor and the memory are configured to implement a method comprising the steps of pairing the electronic device with the smartphone; receiving a set of instructions from the smartphone; and upon receiving the set of instructions, implement a plurality of features of the smartphone on the electronic device and the display. The plurality of features can be voice-guided navigation and notifications for incoming calls, incoming messages, and alerts.

In one implementation of the handlebar apparatus, the electronic device further comprises a rechargeable power source encased within the housing.

In one implementation of the handlebar apparatus, the external computing device can be a smart watch worn by the rider, wherein the processor and the memory are configured to implement a method comprising the steps of pairing the electronic device with the smartwatch; receiving a set of instructions from the smartwatch; and upon receiving the set of instructions, implement a plurality of features of the smartwatch on the electronic device and the display.

In one aspect, disclosed is a handlebar apparatus for electric two-wheeler and three-wheeler vehicles, the handlebar apparatus comprising: a handlebar of an elongated profile, a middle section of the handlebar has a casing, the casing has a base, side walls, and an open top, two ends of the handlebar configured as two tubular handles; an electronic device configured to be mounted within the casing, the electronic device comprises: a housing, a touch interface coupled to the housing and configured to receive inputs from a user, a processor encased with the housing, and memory coupled to the processor(s); and one or more sensors configured to sense motor telemetry and data, drivetrain telemetry and data, transmission telemetry and data and throttling and braking, wherein the one or more sensors are operably coupled to the electronic device, the electronic device upon receiving input from the one or more sensors is configured to send commands to the transmission, powertrain and braking assembly of the vehicle.

In one implementation, the handlebar apparatus comprises a grip throttle coupled to a sensor of the one or more sensors for throttling input. The handlebar apparatus further comprises a swipe gesture touchpad coupled to a sensor of the one or more sensors, the swipe gesture touchpad integrated with the handlebar in proximity to one of the two tubular handles, the swipe gesture touchpad configured to receive input as gestures. The swipe gesture touchpad is configured to receive throttling input. The swipe gesture touchpad is configured to receive braking input. The swipe gesture touchpad is configured to receive a first gesture and a second gesture for the throttling input, the first gesture comprises swiping upwards, and the second gesture comprises swiping downwards. The swipe gesture touchpad is configured to receive a third gesture for the braking input. The first gesture, the second gesture, and the third gesture are configured in the electronic device. The handlebar apparatus further comprises a brake lever coupled to a sensor of the one or more sensors for the braking.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a top and side perspective view of a handlebar apparatus having a handlebar and an electronic device, according to an exemplary embodiment of the present invention.

FIG. 2 is a top view of the handlebar apparatus shown in FIG. 1, according to an exemplary embodiment of the present invention.

FIG. 3 shows the handlebar of the handlebar apparatus having a casing in the middle for an electronic device and ends configured as handles, according to the present invention.

FIG. 4 shows a bottom and side perspective view of the electronic device, according to the present invention.

FIG. 5 is a top and side perspective view of the electronic device, according to an exemplary embodiment of the present invention.

FIG. 6 is a block diagram showing an exemplary implementation of the electronics in the vehicle for the brake-by-wire operation, according to an exemplary embodiment of the present invention.

FIG. 7 is a block diagram showing the sensors connected to the ECU, according to an exemplary embodiment of the present invention.

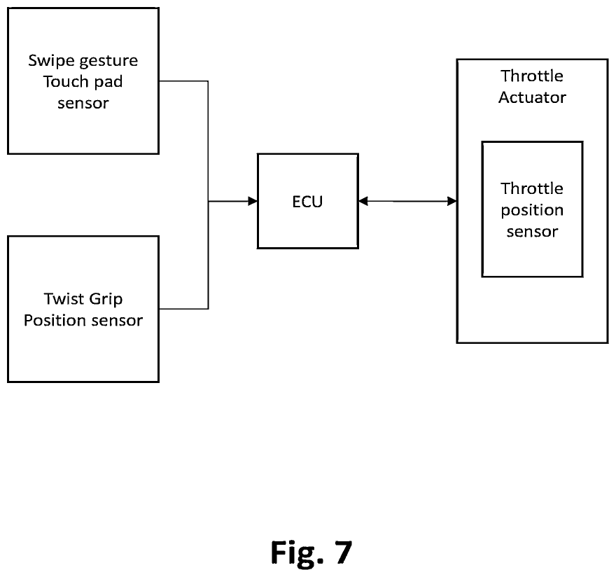

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting to embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

Disclosed is a handlebar apparatus for a vehicle that is an electric two-wheeler or three-wheeler including e-bikes, e-bicycles, e-trikes and e-scooters. The disclosed apparatus provides enhanced performance, maneuverability, and experience in driving the vehicle. The disclosed apparatus overcomes many of the shortcomings and limitations of conventional electric bikes and trikes, which borrows most of the features from fuel-based vehicles and traditional bicycles. The disclosed apparatus can simplify manufacturing and maintenance of the vehicles by providing a single interface for operating and controlling different electrical components of the vehicle. The interface is interactive allowing a user to change settings, view information, and customize the setup.

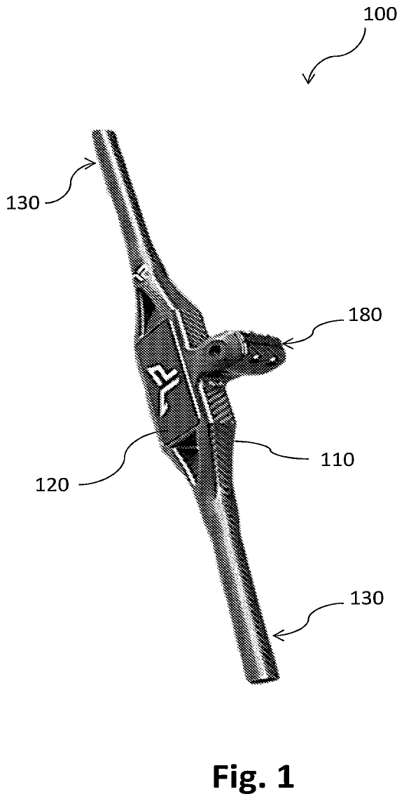

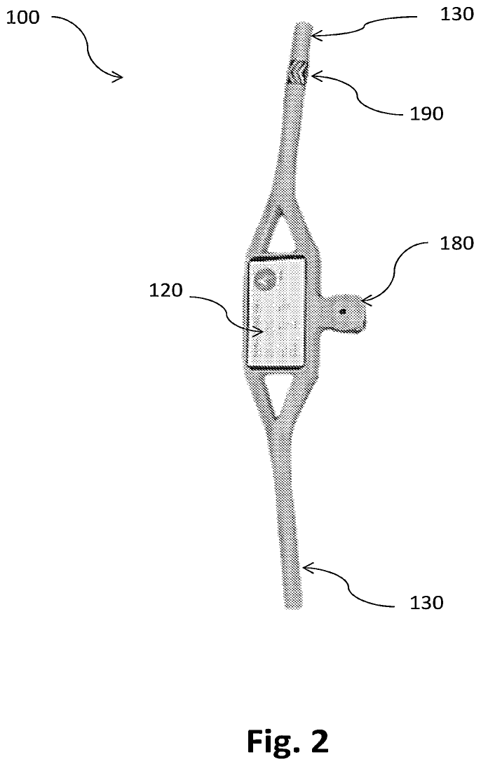

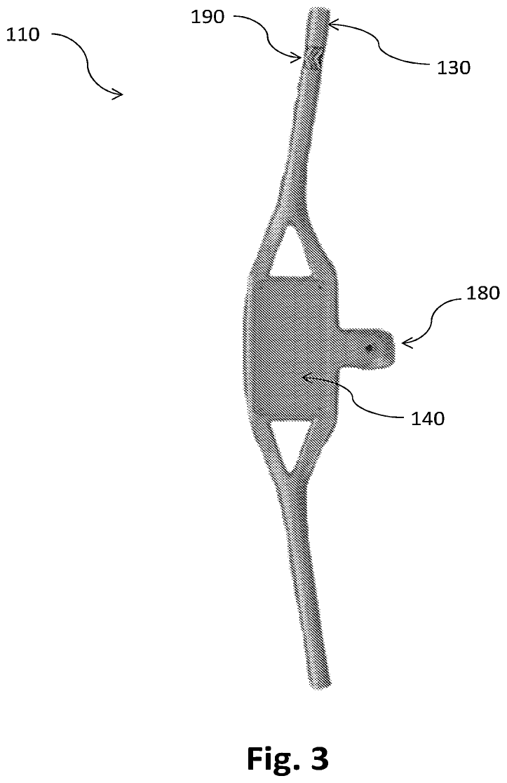

Referring to FIGS. 1 and 2 which show different views of the disclosed handlebar apparatus 100. The handlebar apparatus 100 includes a handlebar 110 and an electronic device 120. The handlebar apparatus can be of an elongated profile having a broad middle with narrower ends. The narrower ends can be of an elongated profile forming the handles 130 that can be grabbed in the hands for steering the vehicle. The user can grip the handle similarly to a conventional handlebar for cycles and bikes. For example, suitable grip and cushions can be applied to the handles for the comfort of the user. The handlebar can be straight or curved to improve maneuverability, comfort, and aerodynamics while driving the vehicle. The handlebar can be made from material such as aluminium, carbon, or various other metals or alloys. The middle portion of the handlebar has a casing 140 to receive the electronic device 120. The casing has a base, side walls, and an open top. The shape and dimensions of the casing can be proportional to the shape and dimensions of the electronic device. FIG. 3 shows the handlebar of the handlebar apparatus. The casing shown in FIG. 3 is rectangular that can receive the electronic device of the tablet computer-like profile.

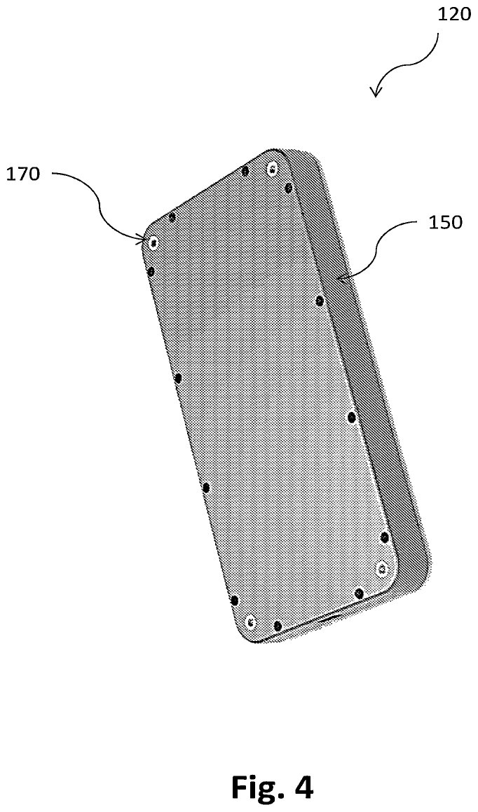

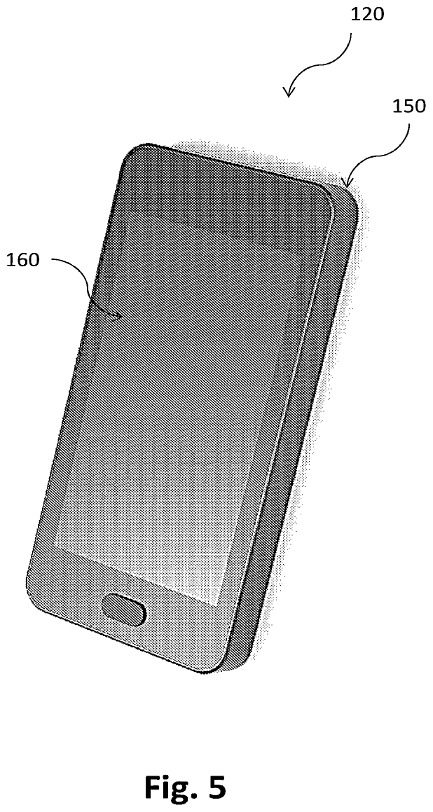

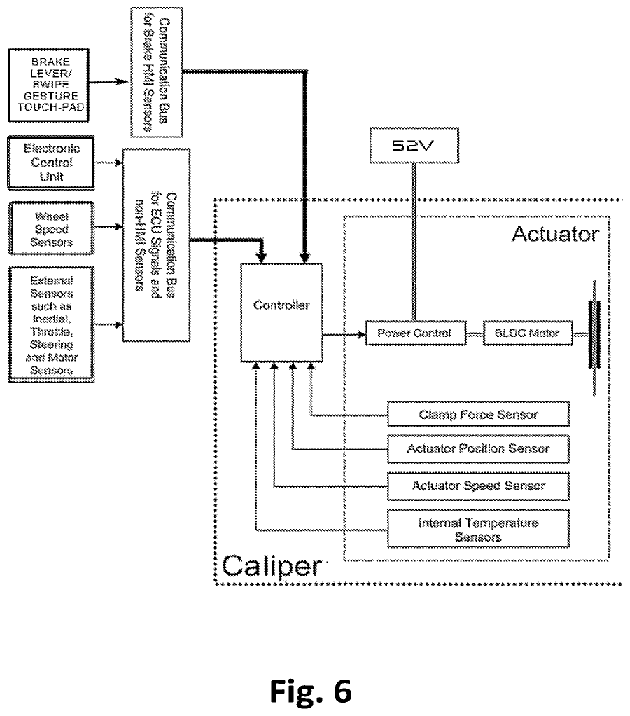

FIGS. 5 and 6 show the electronic device 120, wherein FIG. 5 shows the rear view of the electronic device, and FIG. 6 shows the front view of the electronic device. The electronic device is of a rectangular shape profile that can be received within the casing shown in FIG. 3. The electronic device includes a housing 150 that can encase different components of the electronic device. The housing can be preferably made from shatterproof, waterproof, and weatherproof material for durability and safety. The top of the housing can be open and a touch screen 160 can be coupled to the open top of the housing. The housing with the touch screen can be made waterproof, dustproof, and shatterproof to prevent ingress of water, moisture, and dust. Through the touch screen, the input can be received from the user as well as the touch screen can include a suitable display, such as LCD or TFT for presenting information to the user. The housing can be configured with a suitable attachment for securing the electronic device to the casing. For example, screws can be used to secure the electronic device to the casing. FIG. 4 shows the threads 170 for receiving the screws.

The electronic device can include one or several processor(s) and memory. The processor(s) can be any logic circuitry that responds to, and processes instructions fetched from the memory. The memory may include one or more memory chips capable of storing data and allowing any storage location to be directly accessed by the processor. The memory includes modules according to the present invention for execution by the processor to perform one or more steps of the disclosed methodology. The electronic device can include an inbuilt battery encased within the housing. Preferably, the battery can be rechargeable, and suitable charging circuitry can be included within the housing. The electronic device can be powered by the power supply of the vehicle, and the built-in battery is used when the main power supply is not available. However, such a battery can be optional, and the electronic device can be powered by the power supply of the vehicle only.

The electronic unit can be connected to different sensors of the disclosed handlebar apparatus for receiving input from such sensors. The disclosed electronic unit can connect with the sensors through a wire or wireless connection. For example, the disclosed apparatus can include a throttle sensor and a brake sensor. The throttle sensor can sense the change in speed made by the user. The brake sensor can sense the brake applied by the user. The electronic unit can receive input from the different sensors and the input can be processed by the processor. It is understood that the electronic device can be connected to different sensors of the vehicle, wherein such sensors are known for use in the vehicle. For example, a speed sensor to display the speed of the vehicle, a temperature sensor to display the temperature of the motor, and the like. The use of such sensors is known in the art, the disclosed electronic device can present parameters derived from these sensors on the display of the electronic device.

The memory of the disclosed apparatus can include a suitable operating system and software to perform one or more steps of the disclosed methodology. The software can include instructions to process data including input from sensors for driving the vehicle. The disclosed electronic device can connect to the powertrain of the vehicle, the brake assembly, and the power supply.

The disclosed handlebar apparatus can include a conventionally styled grip throttle that can be rotated in either direction to increase and decrease the speed of the motor. The throttle sensor can sense the rotation of the grip throttle, and the degree of rotation can be sent as input to the electronic unit. Alternatively, a thumb trigger can be used in place of the grip throttle. Preferably, the apparatus can include a swipe-gesture touchpad 190 integrated into the handlebar on side of the handles 130. FIGS. 2 and 3 show the swipe-gesture touchpad integrated into the handlebar nearby the handle so that the swipe-gesture touchpad can be operated by a thumb of the handle while gripping the handle. The gestures can be predefined in the electronic device, and the electronic device can receive input from the swipe-gesture touchpad. For example, swiping up can incrementally increase the speed by a predefined interval and then constant speed follows. Swiping down can incrementally decrease the speed by the predefined interval and then constant speed follows. Traditional brake levers can be used wherein the actuation of the brake levers can be sensed by brake sensors and the electronic unit can activate the brake assembly for the vehicle. Alternatively, the swipe-gesture touchpad can replace the traditional brake levels, wherein gestures can be defined to brake the vehicle. For example, swiping down and stopping can cause the application of brakes.

The disclosed electronic device may present a suitable interface for the user to interact with the handlebar apparatus. The user can be presented with information about the current status of the vehicle. For example, the current speed of the vehicle, distance travelled, charge status, and the like parameters can be displayed through the interface. The electronic device may also provide various in-built applications, such as navigation applications, timer applications, applications to connect a smartphone, and the like applications. The disclosed electronic device may also include an in-built GPS for navigation features. The disclosed electronic device may include suitable modules for pairing with any external computing device, such as a smartphone. The disclosed electronic device may include suitable modules for casting features of the smartphone over the electronic device, such as the CarPlay app available from Apple Inc and Android Auto from Google LLC. The disclosed electronic device may provide different functionalities such as navigation, attending calls, presenting notifications, and the like. The CarPlay app can work with an iOS-enabled smartphone and can provide a smarter and safer way to use the iPhone while driving a car. The driver of the car can get directions, make calls, send, and receive messages, and enjoy music on the display of the electronic device.

The disclosed electronic device can connect with external electronic components, such as sensors of the disclosed handlebar apparatus, sensors of the vehicle, powertrain of the vehicle, battery assembly, external smartphone, and the like through a wired, wireless, or a combination of wired and wireless connection. For a wireless connection, the disclosed electronic device may include suitable network circuitry for connecting, receiving, and or transmitting information to the external electronic device. For example, when the vehicle is started, the disclosed electronic device can pair with the different sensors and swipe touchpad, wherein the status can be shown on the display, and upon successful pairing, a message, such as Ready can be displayed. Examples, of the network that can be used, include Bluetooth® and Wi-Fi. However, the different components can be hardwired if required or may be preferred to be compliant with any standards.

The electronic device can be powered by a rechargeable battery also encased in the housing. Charging circuitry can also be provided for charging the rechargeable battery from an external power supply. In one implementation, the charging circuitry can provide for both wired and wireless charging functionality. Suitable charging ports can also be disposed in the housing that allows connecting an external charging cable further connected to the power supply. Such charging ports can have plugs to prevent the ingress of dust and liquid. Suitable examples of rechargeable batteries can include Lithium-ion batteries. A suitable heat dissipation mechanism can also be incorporated into the housing for removing heat generated by the battery and circuit board.

In certain implementations, the disclosed handlebar apparatus may support drive-by-wire or fly-by-wire-like features in which the cables are replaced by sensors. The disclosed electronic device can sense the throttle input in an electric form and electronically send commands to the power module of the ECU. The throttle can be twist-grip or thumb-operated throttle. Preferably, the traditional throttle controls may be replaced with a pressure pad or swipe/gesture control pad, which is a small, curved touch sensitive TFT panel built into the handlebar. Attached to this panel, on the inside of the handlebar, is a sensor that operates in the same manner as the traditional drive-by-wire throttle but replaces the physical twist-grip or thumb control with a TFT display panel. The swipe gesture control pad can send throttle inputs to the integrated electric device which then sends commands to the powertrain ECU to control the speed of the vehicle.

In certain implementations, the disclosed handlebar apparatus can be provided with brake-by-wire technology for slowing down and stopping the vehicle. Brake levers with sensors can be used. Alternatively, a swipe-gesture TFT pad can be used which is the same as that used for throttling. Perhaps, a single swipe-gesture TFT pad can perform both functions, i.e., braking and throttling. Alternatively, a separate swipe-gesture TFT pad can be provided. The two swipe-gesture TFT pads can be provided on separate handles of the handlebar. The disclosed electronic device upon sensing the braking can send commands to the braking assembly for the vehicle. Braking commands can be for slowing down or stopping the vehicle. For example, each downwards-swipe-gesture over the TFT screen correlates to a command for a predetermined decrease in speed. Each swipe is a resultant step-down in speed increments until the desired speed has been achieved or the vehicle has come to a complete stop. In the event of braking, a downwards swipe followed by continuous pressure being applied to the TFT screen results in the emergency stop of the vehicle without having to make several downwards-swiping motions. These command signals can be sent by the electronic device to the electric calipers via a communication network. In case, of possible network faults, HMI sensory data can also be directly transmitted to each e-caliper via a separate data bus.

In certain implementations, the disclosed apparatus can provide for the one-finger operation of the acceleration and braking for the vehicles by replacing traditional brake levers, and throttle controls with a single pressure-operated touchpad that is connected to the touch-screen electronic device via fly-by-wire OR drive-by-wire technologies having cables replaced by sensors.

In certain implementations, most of the function of the vehicle can be performed through the electronic device and integrated sensors replacing the traditional buttons or levers.

In certain implementations, the disclosed electronic device can receive data, telemetry, instructions, and requests from both internal and external devices, including sensors, IoT devices, Smart-Phones and Smart-Watches. This information is displayed via the touchscreen display as a multi-functional user dashboard for the device.

In certain implementations, disclosed is a handlebar apparatus for electric two-wheeler and three-wheeler vehicles, the handlebar apparatus comprising a handlebar of an elongated profile, a middle section of the handlebar has a casing, the casing has a base, side walls, and an open top, two ends of the handlebar configured as two handles; an electronic device configured to be mounted within the casing, the electronic device comprises: a housing, a touch interface, with LED display, coupled to the top of the housing and configured to display all information for the user, receive inputs from a user, receive data, telemetry, commands and requests from one or more sensors in the transmission, motor, drivetrain, ECU's, drive-by-wire and brake-by-wire controls, the electronic device configured to work as the computer management system of the entire electric two-wheeler or three-wheeler vehicles, the electronic device configured to manage, control and replace the functions of all traditional buttons required for the operation of electric two-wheeler and three-wheeler vehicles, the electronic device configured to be the user interface for all internal controls of the electric two-wheeler and three-wheeler vehicles as well as the externally connected smartphone or smartwatch. The handlebar apparatus further comprises processor(s) encased with the housing, a memory coupled to the processor; and one or more sensors configured to sense motor, transmission and drivetrain data, telemetry, inputs and outputs; and one or more sensors configured to sense throttling and braking, wherein the one or more sensors operably coupled to the electronic device, or communicate with the electronic device with Wi-Fi, Bluetooth®, the electronic device upon receiving input from the one or more sensors are configured to send commands to the powertrain of the vehicle and braking ECU, actuators and assembly of the vehicle.

The handlebar apparatus further comprises a grip throttle coupled to a sensor of the one or more sensors for throttling input. The handlebar apparatus further comprises a swipe gesture touchpad coupled to a sensor of the one or more sensors, the swipe gesture touchpad integrated within the handlebar in proximity to one of the two handles, the swipe gesture touchpad configured to receive input as gestures, the swipe gesture touchpad to then send these input signals to the electronic device in order for the throttle and braking functions to be controlled as required. The swipe gesture touchpad is configured to receive throttling input, where each upwards-swipe input by the operator is equal to a predetermined increase in speed, until the maximum operating speed of the vehicle is reached.

The swipe gesture touchpad is configured to receive braking input, where each downwards-swipe input by the operator is equal to a predetermined decrease in speed, until the vehicle comes to a complete stop. The swipe gesture touchpad is configured to receive a first upward-swiping gesture to begin forward motion and additional upwards gestures for the throttling input, and the first downwards-swiping gesture to begin the braking/slowing down motion and additional gestures for the braking input, the throttle inputs gesture comprises swiping upwards, and the braking inputs gesture comprises swiping downwards. The swipe gesture touchpad is configured to receive a third gesture for the braking input. The third gesture being a downwards swipe gesture followed by a continued pressure on the touchpad to come to a complete stop without the need for multiple downward-swiping gestures. The first gesture, the second gesture, and the third gesture are configured in the electronic device by a set of predetermined parameters for the forwards and braking motion, limits, and control of the vehicle. The handlebar apparatus, in the traditional brake-by-wire control version, further comprises a brake lever coupled to a sensor of the one or more sensors for the braking.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A handlebar apparatus for electric two-wheeler and three-wheeler vehicles, the handlebar apparatus comprising:
a handlebar of an elongated profile, a middle section of the handlebar has a casing, the casing has a base, side walls, and an open top, two ends of the handlebar configured as two handles;
an electronic device configured to be mounted within the casing, the electronic device configured to electronically control an operation of a vehicle and receive data from one or more sensors in the vehicle, the electronic device comprises:
a housing,
a touch interface with a display coupled to the top of the housing and configured to display information for the user and receive inputs from the user, the inputs are for operating the vehicle and manipulating predefined setting of the vehicle,
a processor encased within the housing, and
a memory coupled to the processor; and
one or more sensors configured to sense throttling and braking, wherein the one or more sensors are operably coupled to the electronic device, the electronic device upon receiving input from the one or more sensors is configured to send commands to a powertrain, a braking assembly, and an electronic control unit of the vehicle.

2. The handlebar apparatus according to claim 1, wherein the handlebar apparatus further comprises:
a brake-by-wire grip throttle coupled to a sensor of the one or more sensors for throttling input.

3. The handlebar apparatus according to claim 1, wherein the handlebar apparatus further comprises:
a swipe gesture touchpad coupled to a sensor of the one or more sensors, the swipe gesture touchpad integrated within the handlebar in proximity to one of the two handles, the swipe gesture touchpad configured to receive input as gestures.

4. The handlebar apparatus according to claim 3, wherein the swipe gesture touchpad is configured to receive throttling input.

5. The handlebar apparatus according to claim 4, wherein the swipe gesture touchpad is configured to receive braking input.

6. The handlebar apparatus according to claim 5, wherein the swipe gesture touchpad is configured to receive a first upward-swiping gesture to begin forward motion and additional upwards gestures for the throttling input, and a first downwards-swiping gesture to begin braking/slowing down motion and additional gestures for the braking input, the throttle inputs gesture comprises swiping upwards, and the braking inputs gesture comprises swiping downwards, where each downwards-swipe input by the operator is equal to a predetermined decrease in speed, until the vehicle comes to a complete stop.

7. The handlebar apparatus according to claim 6, wherein the swipe gesture touchpad is configured to receive a downwards swipe gesture followed by a continued pressure on the swipe gesture touchpad resulting in stopping of the vehicle.

8. The handlebar apparatus according to claim 7, wherein the gestures for the swipe gesture touchpad are configured in the electronic device.

9. The handlebar apparatus according to claim 1, wherein the handlebar apparatus further comprises:
a brake-by-wire brake lever coupled to a sensor of the one or more sensors for the braking.

10. A method for operating an electric two-wheeler or three-wheeler vehicle, the method comprising:
providing a handlebar apparatus comprising:
a handlebar of an elongated profile, a middle section of the handlebar has a casing, the casing has a base, side walls, and an open top, two ends of the handlebar configured as two handles,
an electronic device configured to be mounted within the casing, the electronic device configured to electronically control an operation of the vehicle and receive data from one or more sensors in the vehicle, the electronic device comprises:
a housing,
a touch interface with a display coupled to the top of the housing and configured to display information for the user and receive inputs from the user,
a processor encased within the housing, and
a memory coupled to the processor, and
one or more sensors configured to sense throttling and braking, wherein the one or more sensors are wirelessly coupled to the electronic device, the electronic device upon receiving input from the one or more sensors is configured to send commands to a powertrain, a braking assembly, and an electronic control unit of the vehicle;
receiving, by the electronic device, throttling input from the one or more sensors; and
receiving, by the electronic device, braking input from the one or more sensors.

11. The method according to claim 10, wherein the handlebar apparatus further comprises:
a grip throttle coupled to a sensor of the one or more sensors for throttling input.

12. The method according to claim 10, wherein the handlebar apparatus further comprises:
a swipe gesture touchpad coupled to a sensor of the one or more sensors, the swipe gesture touchpad integrated within the handlebar in proximity to one of the two handles, the swipe gesture touchpad configured to receive input as gestures.

13. The method according to claim 12, wherein the swipe gesture touchpad is configured to receive throttling input.

14. The method according to claim 13, wherein the swipe gesture touchpad is configured to receive braking input.

15. The method according to claim 14, wherein the swipe gesture touchpad is configured to receive a first upward-swiping gesture to begin forward motion and additional upwards gestures for the throttling input, and a first downwards-swiping gesture to begin braking/slowing down motion and additional gestures for the braking input, the throttle inputs gesture comprises swiping upwards, and the braking inputs gesture comprises swiping downwards, where each downwards-swipe input by the operator is equal to a predetermined decrease in speed, until the vehicle comes to a complete stop.

16. The method according to claim 15, wherein the swipe gesture touchpad is configured to receive a downwards swipe gesture followed by a continued pressure on the swipe gesture touchpad resulting in stopping of the vehicle.

17. The method according to claim 16, wherein the gestures for the swipe gesture touchpad are configured in the electronic device.

18. The method according to claim 10, wherein the handlebar apparatus further comprises:
a brake lever coupled to a sensor of the one or more sensors for the braking.
